(19) United States
(12) Patent Application Publication
(10) Pub. No.: US 2016/0334121 A1
(43) Pub. Date: Nov. 17, 2016

(54) ENVIRONMENT CONTROL SYSTEM, CONTROL DEVICE, PROGRAM

(71) Applicant: PANASONIC INTELLECTUAL PROPERTY MANAGEMENT CO., LTD., Osaka (JP)

(72) Inventor: Fumiaki OOBAYASHI, Osaka (JP)

(21) Appl. No.: 15/111,170

(22) PCT Filed: Dec. 24, 2014
(86) PCT No.: PCT/JP2014/006416

§ 371 Date: Jul. 12, 2016

(30) Foreign Application Priority Data
Jan. 14, 2014 (JP) 2014-004435
May 13, 2014 (JP) 2014-099414
Jun. 11, 2014 (JP) 2014-120822

(51) Int. Cl. F24F 11/00

(52) U.S. Cl. CPC F24F 11/0001; F24F 11/0079; G05B 2219/2614

(57) ABSTRACT

An environment control system includes an environment forming device, and a control device. The environment forming device performs at least one of formation of an air flow in a work space and ventilation of the work space. The control device controls operation of the environment forming device. The control device controls the environment forming device such that a concentration degree is maintained or improved, the concentration degree being a degree of concentration of attention of a user who is present in the work space.

### TECHNICAL FIELD

This invention, in general, relates to environment control systems, control devices, and programs, and specifically relates to an environment control system configured to control environmental factors that influence the work efficiency of a user in a work space, a control device to be used in this environment control system, and a program for causing a computer to function as a control device to be used in the environment control system.

### BACKGROUND ART

In general, work efficiency of a user who works in a work space such as a learning space or an office space is influenced by a degree of concentration of attention (hereinafter, referred to as “concentration degree”). Also, a concentration degree of a user changes due to various environmental factors. Accordingly, technologies for controlling the environmental factors that influence the concentration degree of a user have been proposed (refer to JP 2009-59677A (hereinafter, referred to as Document 1) and JP 2003-245356A (hereinafter, referred to as Document 2), for example). An illumination environment of the environmental factors in a work space in which a user exists is controlled in both the technologies described in Document 1 and Document 2.

In the technology disclosed in Document 1, single wavelength light is added to illumination of emitting white light, in order to improve the work efficiency by increasing the alertness level. In Document 1, by adopting this configuration, the work efficiency can be improved without causing lighting energy to increase excessively.

On the other hand, Document 2 discloses a technology in which the illumination intensity in a time slot after lunch is set higher than a normal illumination intensity, and the illumination intensity in other time slots is set lower than the normal illumination intensity. According to this configuration, in Document 2, the work efficiency can be improved in the time slot after lunch, and a total energy consumption amount can be suppressed.

Incidentally, in order to increase the work efficiency of a user, the wavelength components included in illumination light are focused on in Document 1 and the intensity of illumination light is focused on in Document 2, and therefore the user may have an odd feeling due to a change in color tone and a change in brightness. Also, there is a possibility that the work efficiency will not be sufficiently increased with a visual stimulus of such an extent that an odd feeling does not result.

Also, although technologies have been known in which an olfactory stimulus or an auditory stimulus is used in order to improve the concentration degree of a user, individual differences are large in responses to the olfactory stimulus, and a technology in which the auditory stimulus is applied may cause noise and also possibly hinder communication.

### DISCLOSURE OF THE INVENTION

Accordingly, an object of the present invention is to provide an environment control system in which the concentration degree of a user can be maintained or improved without using any of visual stimulus, auditory stimulus, and olfactory stimulus. Furthermore, an object of the present invention is to provide a control device to be used in this environment control system, and a program that causes a computer to function as the control device to be used in the environment control system.

An environment control system according to an aspect of the present invention includes: an environment forming device configured to perform at least one of formation of an air flow in a work space and ventilation of the work space; and a control device configured to control operation of the environment forming device. The control device is configured to control operation of the environment forming device such that a concentration degree is maintained or improved, the concentration degree being a degree of concentration of attention of a user who is present in the work space.

A control device according to an aspect of the present invention is to be adopted in the environment control system described above.

A program according to an aspect of the present invention causes a computer to function as the control device to be adopted in any of the above-described environment control systems. Also, the aspect is not limited to the program, and may be a computer-readable storage medium that stores the program.

According to the aspects of the present invention, a configuration is adopted in which, using an environment forming device that performs at least one of formation of an air flow in a work space and ventilation of the work space, the environment forming device is controlled such that a concentration degree of a user is maintained or improved. Accordingly, the concentration degree of the user can be maintained or improved without using any of a visual stimulus, an auditory stimulus, and an olfactory stimulus.

### BRIEF DESCRIPTION OF THE DRAWINGS

A preferable embodiment according to the present invention will be described in detail. Other features and advantages of the present invention will become apparent from the following detailed description with reference to the attached drawings:

FIG. 1 is a block diagram illustrating an embodiment;

FIG. 2 is a schematic configuration diagram illustrating the embodiment;

FIG. 3 is a diagram illustrating an exemplary measurement for quantifying a concentration degree in the embodiment;

FIG. 4 is a diagram illustrating an exemplary effect of the embodiment;

FIG. 5 is a block diagram illustrating another exemplary configuration of the embodiment;

FIG. 6 is a diagram illustrating an exemplary operation of the embodiment; and

FIG. 7 is a diagram illustrating an exemplary effect of the embodiment.

### DESCRIPTION OF EMBODIMENTS

A term “concentration degree” will be used in a present embodiment described hereinafter. Note that in a case where the concentration degree is handled quantitatively, a concentration time ratio that will be described next can be used as an index, for example. The concentration time ratio refers to a ratio of a time in a concentration state relative to a work time when a person has performed intellectual work.

Concept of the concentration time ratio is based on a model that includes a state in which a cognitive resource of a person is allocated to a work target and a state in which the cognitive resource is not allocated to the work target in a period in which the person performs intellectual work. In this model, the state in which the cognitive resource is allocated to a target and work is in progress is referred to as a “working state”, and the state in which the cognitive resource is not allocated to the target and the user is taking a rest over a long period of time is referred to as a “long-term rest”. Also, the state in which, although the cognitive resource is allocated to the target, work processing is stopped unconsciously in a short period of time is referred to as a “short-term rest”. The state of the “short-term rest” is known to occur physiologically at a given probability in a period in the “working state”.

The “working state” and the “short-term rest” are regarded as the concentration state since the cognitive resource is allocated to the target, and the “long-term rest” is regarded as an non-concentration state since the cognitive resource is not allocated to the target. Accordingly, by isolating three states, namely the “working state”, the “short-term rest”, and the “long-term rest”, or by isolating two states, namely a state of the “working state” and the “short-term rest” and a state of the “long-term rest”, the concentration degree can be quantified.

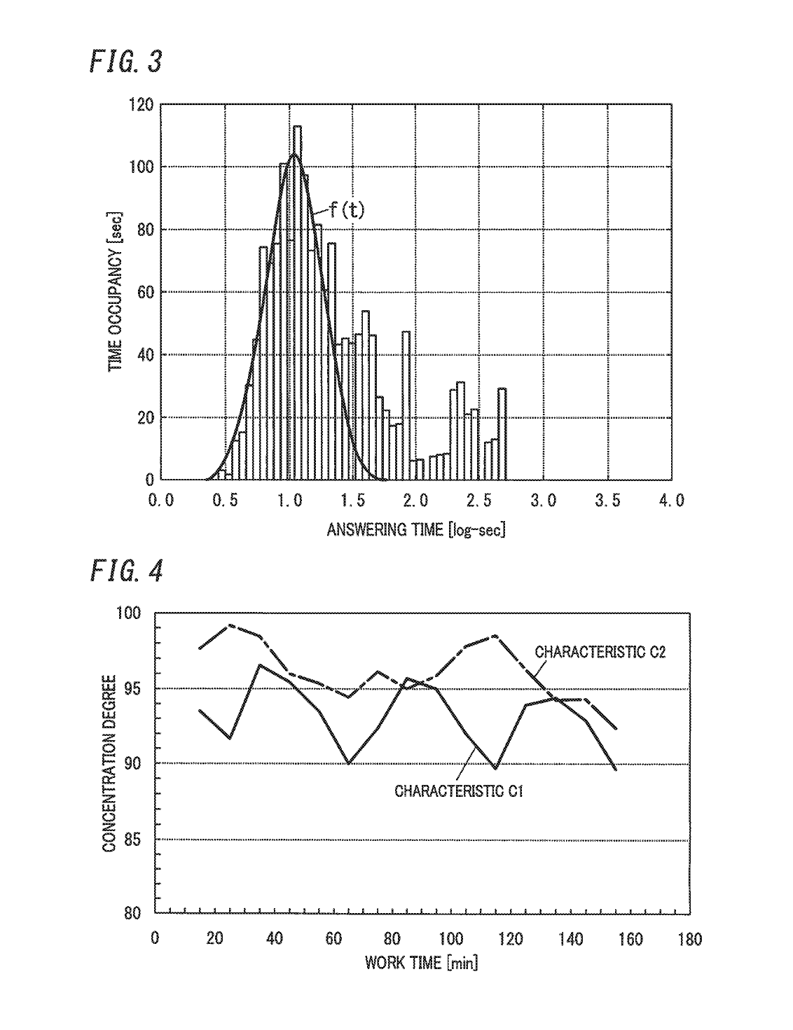

Here, a technology in which a period of being in the concentration state in a predetermined period is obtained, instead of a technology in which the concentration degree is measured in real time, will be described. In this case, many questions with little variation in difficulty are presented to a test subject whose concentration degree is to be measured, and an amount of time required for the test subject to answer each question (answering time) is measured for all the questions, for example. Next, a histogram is generated by obtaining frequencies for respective sections of the answering time, as shown in FIG. 3. In the case where the above-described model has been adopted, this histogram is estimated to represent a result in which the concentration state and the non-concentration state are both included.

An experimental result has been obtained in which this histogram has a shape having two or more peaks when appropriate questions were given. That is, two or more mountain-shaped regions appear in the histogram. A mountain-shaped region that includes a peak whose answering time is shorter than those of other peaks can be interpreted as indicating a state in which the “working state” and the “short-term rest” are mixed, and mountain-shaped regions including other peaks can be interpreted as indicating a state in which the “working state”, the “short-term rest”, and the “long-term rest” are mixed. This is because, even in the concentration state, the answering time may possibly become long due to variation in difficulty of questions.

Here, when an ideal state in which the difficulties of questions are the same is assumed, the mountain-shaped region appearing in the histogram is estimated to be approximated by a probability density function f(t) having a log-normal distribution as a function of the answering time t. In reality, however, the variation in difficulty of questions cannot be completely removed. Accordingly, as for the mountain-shaped region whose average answering time is shorter among two mountain-shaped regions, only a portion whose answering time is shorter than the peak and a portion in the vicinity of the peak are interpreted to match the probability density function f(x) having the log-normal distribution. Then, parameters (expected value and variance) of the probability density function f(x) are determined so as to approximate these portions.

When the parameters of the probability density function f(x) have been determined, the expected value of the answering time can be determined. The result obtained by multiplying the obtained expected value by the number of questions can be interpreted as a length of time of being in the concentration state out of the total time (total answering time) from the start to the end of question solving by the test subject. Also, a time resulting from subtracting the time of being in the concentration state from the total answering time can be interpreted as a length of time of being in the non-concentration state. Thus, the time ratio of the time of being in the concentration state relative to the total answering time is defined as a concentration time ratio, and a concentration degree is determined to be higher as the concentration time ratio is larger.

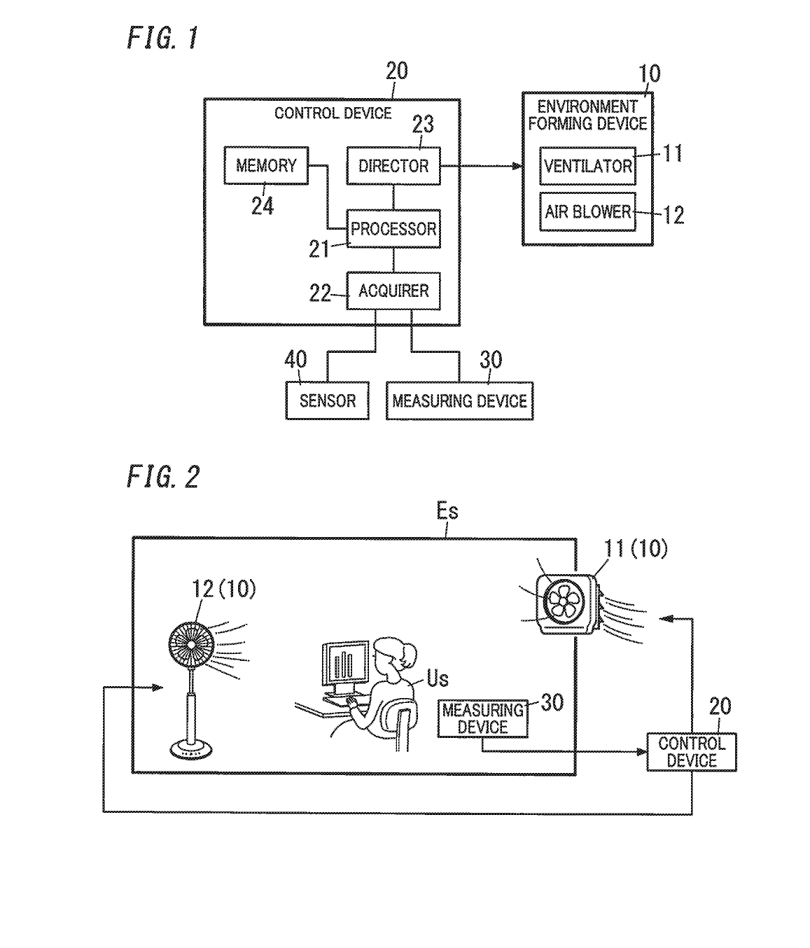

The aforementioned concentration time ratio is an exemplary index of the concentration degree, and the concentration degree can be quantified using other later-described indices. In particular, work is needed in which the test subject is given many questions and caused to answer them in order to obtain the concentration time ratio, and the index of the concentration degree is difficult to obtain during the work. Therefore, in order to control an environment forming device 10 (refer to FIG. 1) according to the concentration degree, an index of the concentration degree equivalent to the concentration time ratio needs to be measured by using another technology.

Incidentally, it is known that, in the case where questions are continuously given to a test subject over a relatively long time (3 hours, for example), if a change is not applied to the work environment, the concentration degree obtained in every relatively short period (1 to 10 minutes, for example) changes in the manner of a characteristic C1 shown in FIG. 4. That is, in the case where intellectual work continues over a relatively long time, the concentration degree repeatedly increases and decreases changing in every 20 to 40-minute period. In short, the concentration degree has a characteristic in which, when intellectual work is continuously performed, increasing and decreasing are repeated such that the concentration degree decreases from a high state, and thereafter recovers to increase, and again decreases while time elapses. Note that although individual differences exist in the period with which the concentration degree changes, an approximate general characteristic can be grasped. When focusing on the change of the concentration degree over time, as described above, it can be said that lowering of the concentration degree needs to be suppressed in order to increase the work efficiency in intellectual work.

Incidentally, it is known that the concentration degree of a user in a work space changes according to environmental factors. Although technologies in which environmental factors (such as illumination, music, and aroma, for example) that apply a visual stimulus, an auditory stimulus, an olfactory stimulus, or the like are caused to change have been proposed in order to increase the work efficiency, change in the environmental factors may possibly hinder work in each case. Thus, the present embodiment has adopted a configuration in which an air environment is to be changed in a work space so as to maintain or improve the concentration degree of a user in the work space.

The air environment includes, in addition to concentrations of (physical, chemical, and biological) substances in the air, a temperature, a relative humidity, and air flow speed. Dust, Asian Dust, and particulate matter (such as PM10 or PM2.5) are known as the physical substances in the air. Also, carbon monoxide, carbon dioxide, aldehydes (formaldehyde, specifically), and VOC (Volatile Organic Compounds) are known as the chemical substances in the air. Mold, viruses, pollen, and the like are known as the biological substances in the air.

Accordingly, ventilation of a work space, formation of air flow in the work space, adjustment of temperature or humidity in the work space, removal of substances in the air, or the like are conceivable in order to change the air environment. The formation of air flow and the adjustment of temperature or humidity also influence the comfort of the user. In the present embodiment, a case is envisioned in which a work space Es in which a user Us is present is indoors, as shown in FIG. 2. Also, a case is envisioned in which the environment forming device 10 uses both a ventilator 11 configured to take in outside air to the work space by discharging the air in the work space Es and an air blower 12 such as an electric fan or a circulator configured to form an air flow inside the work space Es. Of course, the environment forming device 10 may include one of the ventilator 11 and the air blower 12, and may possibly use another environment forming device 10 such as an air conditioner or an air cleaner. A case where the air conditioner is used as the environment forming device 10 will be described later.

The ventilator 11 may be configured such that air is discharged from the work space Es to an outer space at the same time as the air is taken in from the outer space to the work space Es, and heat exchange is performed during performing intake and discharge. Furthermore, a ventilation device used for ventilation may be an opening portion such as a window for performing natural ventilation, other than the ventilator 11 configured to perform mechanical ventilation. These environment forming devices 10 may be used independently, or used in combination.

The operation of the environment forming device 10 is controlled by a control device 20, as shown in FIG. 1. Since the concentration degree changes over time in a period in which intellectual work is performed, as described above, the control device 20 causes the environment forming device 10 to operate so as to form an air environment in which the concentration degree is maintained or improved in accordance with a timing when the concentration degree decreases. The timing when the concentration degree decreases is determined based on the concentration degree of a user monitored by using a measuring device 30.

The control device 20 includes a device that includes a processor configured to operate according to a program as a main hardware element. A microcontroller integrally provided with a memory, a microprocessor to which a memory is separately provided, or the like is used as this type of device. That is, the control device 20 is configured by using a computer. A program is used to cause the computer to function as the control device 20 to be described later. The program may be stored in a ROM (Read Only Memory) in advance, provided by a computer-readable storage medium, or provided via an electrical communication network such as the Internet.

The control device 20 includes an acquirer 22 configured to acquire information relating to the concentration degree from the measuring device 30, and is configured to determine operations of the environment forming device 10 with a processor 21 evaluating the concentration degree based on the information acquired via the acquirer 22. The control device 20 includes a director 23 configured to direct operations of the environment forming device 10, and is configured to direct operation contents to the environment forming device 10 based on the operations determined by the processor 21.

The processor 21 is configured to evaluate the concentration degree of a user, using the information that the acquirer 22 has acquired from the measuring device 30, and cause the environment forming device 10 to operate such that the air environment is changed at a timing when the concentration degree decreases by a predetermined threshold from a state in which the concentration degree is at a maximum. Also, the processor 21 can adopt a point in time when the concentration degree decreases to a predetermined reference value as the timing when the environment forming device 10 is caused to operate such that the air environment is changed. Alternatively, the processor 21 may be configured to calculate a change rate of the concentration degree when the concentration degree lowers and compare the calculated change rate with a predetermined range, and may adopt a point in time when the concentration degree rapidly lowers as the timing when the environment forming device 10 is caused to operate such that the air environment is changed.

The measuring device 30 needs to monitor the concentration degree of a user in a non-invasive manner, and detect the change of the concentration degree at relatively short time intervals (1 to 10 minutes, for example). Although the measuring device 30 is desirably contactless in addition to being non-invasive, an element such as a head band or a wristband that is brought into contact with the user may be included.

A camera configured to capture a user is used as the measuring device 30, for example. The acquirer 22 is configured to acquire pieces of information such as bodily movement, posture, pupil diameter, and blinking frequency using an image of the user captured by the camera, and the processor 21 is configured to obtain an evaluation value of the concentration degree by using these pieces of information independently or in combination. Here, the processor 21 is configured such that these pieces of information and the concentration time ratio described above are associated and are registered in a lookup table (memory 24). The processor 21 is configured to, when the concentration degree is evaluated, collate the information obtained from the acquirer 22 with the lookup table and convert to the concentration time ratio so as to quantify the concentration degree.

Note that the technology of converting the information obtained from an image captured by a camera to the concentration time ratio, as described above, is an example of a technology of quantifying the concentration degree, and the measuring device 30 may be configured to monitor other information as long as the information is a guide of the concentration degree. For example, the measuring device 30 may adopt a configuration in which a change of skin temperature at a specific part of a user is detected with a thermograph, or a configuration in which a bioelectric current such as a brain wave is detected.

The processor 21 is configured to determine control contents of the environment forming device 10 depending on the evaluated concentration degree in the following manner, for example. In the case where the air blower 12 is used as the environment forming device 10, when the processor 21 determines that a timing has come when the concentration degree is to be maintained or improved, the processor 21 causes the air blower 12 to operate such that the speed of an air flow that is sent to the user is increased. That is, when the air blower 12 has been stopped before the timing, the processor 21 causes the air blower 12 to start operation, and when the air blower 12 has been operating before the timing, the processor 21 causes the air blower 12 to increase an air flow amount therefrom. When the concentration degree of a user lowers, the alertness level also often lowers. In contrast, if the speed of an air flow that is sent to the user from the air blower 12 is increased, an appropriate sensory stimulus is applied to the user, the alertness level is maintained or improved, and as a result the concentration degree is expected to be maintained or improved.

In the case where the ventilator 11 is used as the environment forming device 10, when the processor 21 determines that a timing has come when the concentration degree is to be maintained or improved, the processor 21 causes the ventilator 11 to operate such that outside air is taken into the work space. That is, similarly to the case of the air blower 12, when the ventilator 11 has been stopped before the timing, the processor 21 causes the ventilator 11 to start operation, and when the ventilator 11 has been operating before the timing, the processor 21 causes the ventilator 11 to increase a ventilation capacity thereof.

Here, in the case where the outside air environment is more preferable than the air environment in the work space, as a result of ventilating the air in the work space, the air environment such as carbon dioxide concentration, temperature, and relative humidity is improved. That is, by ventilation, not only is a sensory stimulation applied to the user in the work space, but also a physiological effect is brought to the user. As a result, the alertness level of the user in the work space is maintained or improved, and accordingly, the concentration degree can be expected to be maintained or improved.

In the case where the environment forming device 10 is controlled based on the change in the concentration degree monitored by the measuring device 30, as described above, lowering of the concentration degree can be suppressed as shown by a characteristic C2 in FIG. 4. That is, as a result of the concentration degree is maintained or improved due to the operation of the environment forming device 10, the concentration degree of the user is prevented from lowering greatly over a relatively long period of time. As a result of lowering of the concentration degree being suppressed, the work efficiency can be expected to be improved.

In the above-described exemplary operation, the environment forming device 10 is instructed to change the operating state at a timing when the concentration degree is to be maintained or improved, but a target value of the air environment is not determined. In contrast, the environment forming device 10 may be caused to operate with a determined target value relating to the air environment. In this case, a sensor 40 (refer to FIG. 1) is provided that measures concentration of substances in the air among the parameters of the air environment. Also, the processor 21 is configured to control the operation of the environment forming device 10 by comparing the substance concentration acquired via the acquirer 22 with a target value, the target value of the substance concentration that is measured by the sensor 40 being determined in advance.

The concentration of substances in the air is referred to as air quality, and the air quality includes various environmental factors such as carbon dioxide concentration, oxygen concentration, relative humidity (water vapor concentration), odor components (volatile component: including aldehydes, VOC, and the like), and dust. The sensor 40 is configured to measure an environmental factor to be focused on among the environmental factors included in the air quality, and the processor 21 is configured to control the operation of the environment forming device 10 using the concentration of the environmental factor measured by the sensor 40 and the target value thereof. The target value may be statistically determined based on measurement values, the target value being the value at which the concentration degree of the user lowers or rises.

Here, the processor 21 is configured to cause, in a period in which the environment forming device 10 is caused to operate so as to maintain or improve the concentration degree, the operation of the environment forming device 10 to return to an original state when the environmental factor measured by the sensor 40 reaches the target value. For example, in the case where the environmental factor to be focused on is carbon dioxide concentration, the target value may be set to 400 ppm or the like.

In this case, the operation is such that, while the ventilator 11 is caused to operate so as to increase an introduction amount of the outside air to the work space in order to maintain or improve the concentration degree, the ventilator 11 is caused to return to an original operation when the carbon dioxide concentration decreases to 400 ppm.

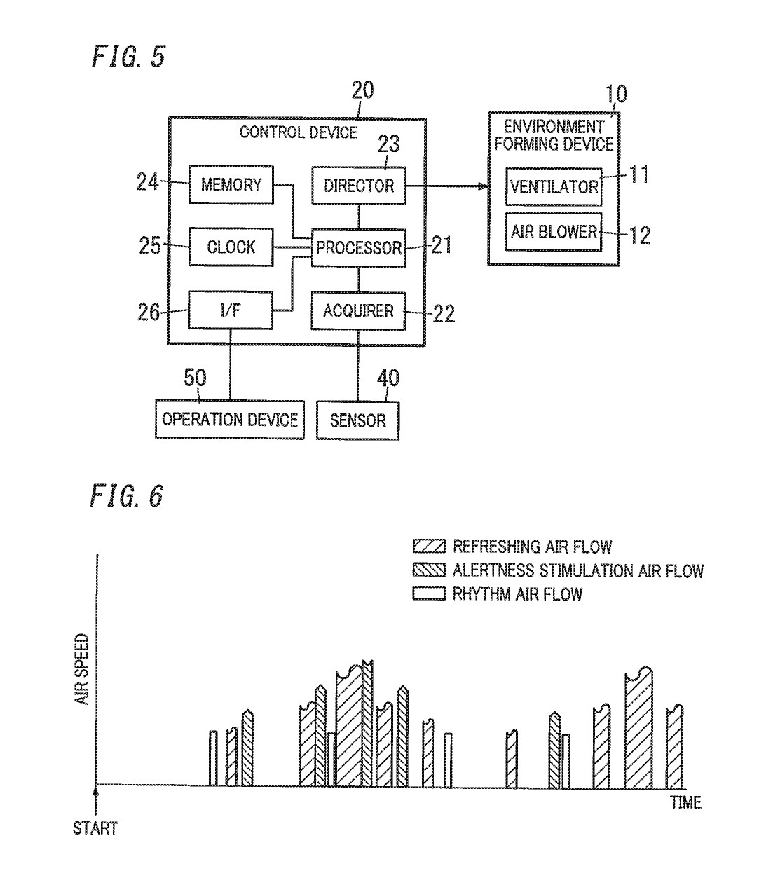

Although the concentration degree of the user is measured by the measuring device 30 in the above-described exemplary operation, a configuration may be adopted in which the control device 20 is provided with a clock 25, as shown in FIG. 5, instead of using the measuring device 30. That is, because the increase and decrease of the concentration degree has periodicity, if the period of the increase and decrease of the concentration degree is obtained in advance, the processor 21 can control the operation of the environment forming device 10 so as to match the period using the clock 25 such that the concentration degree of the user is maintained or improved.

Although individual differences exist in the period of increase and decrease of the concentration degree, if the periods are classified into a plurality of types depending on the attributes (such as age, gender, and character) of the user, and the period of increase and decrease of the concentration degree is statistically obtained for each type, the period can be used to control the environment forming device 10. That is, the processor 21 is enabled to control the environment forming device 10 in accordance with the time measured by the clock 25 depending on the attribute of the user such that the concentration degree is maintained or improved. Note that the point in time when measuring of time starts needs to match the point in time when the user starts intellectual work, and therefore the start of measuring time by the clock 25 needs to be directed using a switch or the like.

An exemplary configuration in which the control device 20 controls the environment forming device 10 without using the measuring device 30 will be described in further detail. The environment forming device 10 is the air blower 12, and the air blower 12 is arranged so as to form an air flow such that air is blown to the user. That is, the air blower 12 functions as an air flow forming device. The control device 20 controls the air blower 12 so as to repeat operation and stop. The parameters that the control device 20 can control with respect to the air blower 12 include a maximum speed of air blown to the user, an operating time during which the air blower 12 forms an air flow, and a stop time during which the air blower 12 stops. Furthermore, the parameters that the control device 20 can control with respect to the air blower 12 may include a timing at which the air blower 12 starts operating for the first time, a portion of the user to which the air blower 12 blows air, or the like.

These parameters are registered in the memory 24 included in the control device 20 in advance. If a switch, a remote controller, or the like is operated at a point in time when the user starts work, thereafter, the control device 20 controls the operation of the air blower 12 based on the parameters.

Incidentally, in the present embodiment, three typical types of approaches are focused on that deal with the change in the concentration degree of the user who performs intellectual work. Here, only three types, namely refreshing, prevention of alertness level lowering, and adjustment of a work rhythm, are assumed as approaches for dealing with the change in the concentration degree. The parameters for controlling the operation of the air blower 12 are set for each of the approaches for dealing with the change in the concentration degree. Hereinafter, an air flow to be generated by the air blower 12 for refreshing will be referred to as a “refreshing air flow”, an air flow to be generated by the air blower 12 in order to deal with the lowering of the alertness level will be referred to as an “alertness stimulation air flow”, and an air flow for suppressing disturbance in the work rhythm will be referred to as a “rhythm air flow”.

The refreshing air flow is generated such that air is blown to the vicinity of a head portion of the user from behind. The concentration degree is considered to be maintained in a period from the start of work until 10 to 15 minutes elapses. The control device 20 controls the refreshing air flow after 10 to 15 minutes has elapsed since the start of the work. That is, a point in time when 10 to 15 minutes elapses after the start of the work is determined to be the time when the control of the air blower 12 is to be started for the refreshing air flow, and refreshing air flows are to be generated at timings when lowering in the concentration degree is anticipated after the time when the control of the air blower 12 is started.

The refreshing air flow is configured such that an operating time during which the air blower 12 is caused to operate is determined in a range from several seconds to several tens of seconds, and a stop time is selected from a range from 2 to 10 minutes. Furthermore, the maximum speed of air to be blown to the user is desirably in a range from 0.4 to 0.7 m/s. The operating time and the stop time are desirably adjusted depending on a degree of lowering in the concentration degree.

For example, in a period in which the elapsed time since the start of control is relatively short, and the concentration degree is maintained, the operating time is set to be short (several seconds to ten and several seconds, for example), the stop time is set to be long (over 5 minutes, for example), or the operating time is set to be short and the stop time is set to be long. On the other hand, in a period in which the elapsed time since the start of control is relatively long, and lowering in the concentration degree is large, the operating time is set to be long (ten seconds to several tens of seconds, for example), the stop time is set to be short (5 minutes or less, for example), or the operating time is set to be long and the stop time is set to be short. Note that the control device 20 can determine that the refreshing air flow is to be generated in a given period. Also, the control device 20 can determine at least one of the stop time and the operating time to be a constant time.

The air speed of the refreshing air flow that is blown to the user in one operating time can be changed according to the elapse of time, or may be constant. Furthermore, the air speed may be set to be small in a period in which lowering of the concentration degree is small, and the air speed may be set to be large in a period in which lowering of the concentration degree is large. That is, it is desirable that the amount of stimulation to the user by the refreshing air flow is made small in a stage in which lowering of the concentration degree is small, and the amount of stimulation to the user by the refreshing air flow is increased as the lowering of the concentration degree increases.

The parameters of the refreshing air flow such as air speed, operating time, and stop time may be changed depending on the environmental factors such as indoor temperature, indoor humidity, outside air temperature, outside air humidity, weather, and the season. For example, in the case where the indoor temperature is high in summer, the air speed of the refreshing air flow is set to be large, the operating time is set to be long, the stop time is set to be short, or two or three types of parameters selecting from the air speed, the operating time, and the stop time are set in combination. On the other hand, in the case where the indoor temperature is moderate in spring or fall, the values of one to three parameters selecting from the air speed, the operating time, and the stop time of the refreshing air flow are desirably set to be approximately in the middle of the variable range.

In the example described above, although the control device 20 only controls parameters selected from the air speed, the operating time, and the stop time of the refreshing air flow, the control device 20 can control a portion of the user to which air is blown, and may also control the temperature of air to be blown to the user from the air blower 12. That is, in the case where the air blower 12 that can change a portion of the user to which air is blown is used, a portion to which air is blown can be changed in one operating time such that air is blown not only to the vicinity of a head portion of the user, but also to a back, an arm, and the like of the user. In the case where the temperature of an air flow to the user can be adjusted, it is desirable that air whose temperature is lowered is blown to the user in a season in which the indoor temperature is high. Note that, in the refreshing air flow, the temperature of an air flow to be blown to the user from the air blower 12 is not higher than the temperature in the surrounding area in any case.

Next, the alertness stimulation air flow relating to lowering of the alertness level will be described. The alertness stimulation air flow is generated such that air is blown to the vicinity of a head portion or the vicinity of a face of the user. Influence of lowering of the alertness level to work can be considered to be small until 10 to 15 minutes elapses from the start of the work. Therefore, the control device 20 performs control of the alertness stimulation air flow after 10 to 15 minutes has elapsed from the start of the work. That is, a point in time when 10 to 15 minutes elapses from the start of the work is determined to be a time when the control of the air blower 12 for the alertness stimulation air flow is to be started, and the alertness stimulation air flow is to be generated at timings when lowering of the concentration degree is anticipated due to the lowering of the alertness level after the time when the control is started. The time difference between the timing when the control of the refreshing air flow is to be started and the timing when the control of the alertness stimulation air flow is to be started is small (5 minutes or less, for example). Therefore, the control device 20 may start control of the refreshing air flow and the alertness stimulation air flow at the same timing.

The alertness stimulation air flow is configured such that an operating time during which the air blower 12 is caused to operate is determined in a range approximately from several seconds to ten seconds, and a stop time is selected from a range from 2 to 10 minutes. Furthermore, the maximum speed of air to be blown to the user is desirably in a range from 1.5 to 3 m/s. The operating time and the stop time are desirably adjusted depending on the alertness level.

For example, in a period in which the elapsed time since the start of control is relatively short, and lowering of the alertness level is small, the operating time is set to be short (several seconds, for example), the stop time is set to be long (5 minutes or more, for example), or the operating time is set to be short and the stop time is set to be long. On the other hand, in a period in which the elapsed time since the start of control is relatively long, and lowering of the alertness level is large, the operating time is set to be long (approximately ten seconds, for example), the stop time is set to be short (5 minutes or less, for example), or the operating time is set to be long and the stop time is set to be short. Note that the control device 20 can determine that the alertness stimulation air flow is to be generated in a given period. Also, the control device 20 can determine at least one of the stop time and the operating time to be a constant time.

The air speed of the alertness stimulation air flow that is blown to the user in one operating time can be changed according to the elapse of time, or may be constant. In the case where the air speed is changed according to the elapse of time, air may be intermittently blown to the user in one operating time. When air is intermittently blown to the user, the stimulation degree increases compared with the case where air is continuously blown to the user, and the effect of increasing the alertness level of the user increases. Furthermore, the air speed may be set to be small in a period in which lowering of the alertness level is small, and the air speed may be set to be large in a period in which lowering of the alertness level is large.

The alertness level of a user is increased with the alertness stimulation air flow by applying stimulus to the user. When stimuli are repeatedly applied, the user becomes accustomed to the stimuli, in general, and therefore, when the alertness stimulation air flows are repeatedly applied, the effect of increasing the alertness level decreases. Therefore, the control device 20 may control the air blower 12 such that the amount of stimulation to the user is small in a period in which lowering of the alertness level is small, and the amount of stimulation to the user increases as the lowering of the alertness level increases. In order to change the amount of stimulation to the user, at least one parameter among the air speed, the operating time, and the stop time may be changed. In order to change the amount of stimulation, combinations of the parameters based on the amount of stimulation are registered in the memory 24 of the control device 20 in advance, and the processor 21 may select an appropriate combination of the parameters from the memory 24.

In the example described above, although the control device 20 only controls parameters selected from the air speed, the operating time, and the stop time of the alertness stimulation air flow, the control device 20 can control a portion of the user to which air is blown, and may also control the temperature of air to be blown to the user from the air blower 12.

That is, in the case where the air blower 12 that can change a portion of the user to which air is blown, a portion to which air is blown can be changed in one operating time such that air is blown not only to the vicinity of a head portion or a face portion of the user, but also to a back, an arm, and the like of the user. Also, because the stimulation degree that the user senses differs depending on the portion to which air is blown, it is effective that the air speed is changed depending on the portion to which air is blown. For example, the air speed of air that is blown to the vicinity of the head portion may be made relatively large, and the air speed of air that is blown to the vicinity of the face may be made relatively small.

In order to blow air to a target portion of the user, the control device 20 controls the air blower 12 such that, in a period of initial setting, air is blown to various portions of the user from the air blower 12. Also, the control device 20 is provided with an interface (hereinafter, referred to as “I/F”) 26 so as to receive input information from an operation device 50 such that the user can notify the control device 20 that air from the air blower 12 is blown to a specific portion of the user. The operation device 50 is a display operation device, and the control device 20 displays a portion to the user via the operation device 50, and instructs the user to perform a specific operation when air is blown to the portion. Although the operation device 50 can be exclusively provided for the control device 20, a terminal device selected from a smartphone, a tablet terminal, a personal computer, and the like may be used as the operation device 50.

In the case where the environment control system having the above configuration, in a period of the initial setting during which the control device 20 controls the air blower 12 such that air is blown to various portions of the user, the user operates the operation device 50 when air is blown to the portion displayed in the operation device 50. The control device 20 stores, in the memory 24, the information that is being given to the air blower 12 at a point in time when the operation device 50 is operated. Here, a delay (time lag) exists between a point in time when the user operates the operation device 50 and a point in time when the air blower 12 was given instruction, and therefore it is desirable that, after the aforementioned information is corrected using a given time as the time lag, corrected information is stored in the memory 24.

As described above, as a result of the user operating the operation device 50 in a point in time when air from the air blower 12 is blown to a specific portion of the user, information in which information given to the air blower 12 is associated with the portion of the user can be stored in the memory 24. In other words, even if the positional relationship between the air blower 12 and the user changes, the control device 20 can control the air blower 12 such that air is blown to a specific portion of the user as a result of the user performing the above-described work in a period of initial setting.

A camera configured to monitor the user and an image processing device configured to perform signal processing on an image captured by the camera may be used in order to blow air from the air blower 12 to a specific portion of the user. That is, a configuration may be adopted in which the image processing device extracts a specific portion of the user from the image of the user captured by the camera, and information for controlling the air blower 12 so as to blow air to the specific portion of the user is extracted using the positional relationship between the camera and the air blower 12. By adopting this configuration, the control device 20 can automatically generate information necessary for blowing air from the air blower 12 to the specific portion of the user in cooperation with the image processing device, without accompanying work by the user using the operation device 50.

Incidentally, in the case where temperature of the air flow to the user can be adjusted, in a season when the indoor temperature is high, air having a lowered temperature is desirably blown to the user. Note that since the alertness stimulation air flow is used for suppressing lowering of the concentration degree due to lowering of the alertness level, the temperature of the air flow to be blown to the user from the air blower 12 is not higher than the temperature in the surrounding area in any case.

Although a portion of the user to which air is blown is not specifically limited in the rhythm air flow for suppressing disturbance of the work rhythm, a stimulus that is easily sensed by the user can be applied by blowing air to the similar portions as the refreshing air flow or the alertness stimulation air flow. In short, in the rhythm air flow as well, air is desirably blown to a face or a head portion that is not covered by clothes.

It is known that a period during which the concentration degree is maintained when intellectual work is performed is approximately 10 to 20 minutes, in general. Accordingly, the concentration degree can be maintained as a result of stimulating the user by blowing the rhythm air flow to the user in intervals of 10 to 20 minutes so as to match the timings when the concentration degree lowers. The rhythm air flow may basically have a constant period, and may be set such that the period is 10 minutes and the operating time is several seconds, for example. Also, the maximum speed of air to be blown to the user is approximately 0.2 m/s, and is set to a value smaller than those of the refreshing air flow and the alertness stimulation air flow. Also, the air speed of the rhythm air flow is kept constant, in principle.

Since the rhythm air flow has a period of 10 minutes, for example, the control device 20 may start performing control of the rhythm air flow after 10 to 20 minutes elapses since the start of work. That is, a point in time when 10 to 20 minutes elapses from the start of work is determined to be a time when the control of the air blower 12 for the rhythm air flow is to be started, and the rhythm air flow is to be generated at intervals of 10 minutes, for example, after the time when the control is started.

The maximum speed, the operating time, and the stop time of air to be blown to the user, and the portion to which air is to be blown with respect to the above described refreshing air flow, the alertness stimulation air flow, and the rhythm air flow are summarized in TABLE 1.

TABLE 1

| Type of air | Air speed | | | |
|---|---|---|---|---|
| flow | (m/s) | Operating time | Stop time | Portion |
| Refreshing | 0.4 to 0.7 | several seconds | 2 to 10 minutes | rear of |
| | | to several 10s | | head |
| | | of seconds | | |
| Alertness | 1.5 to 3.0 | several seconds | 2 to 10 minutes | face, head |
| stimulation | | to 10 seconds | | |
| Rhythm | 0.2 | several seconds | 10 to 20 minutes | face, head |

The control device 20 controls the air blower 12 such that only one air flow selected from the refreshing air flow, the alertness stimulation air flow, and rhythm air flow is generated, or controls the air blower 12 such that two or more air flows selected from the refreshing air flow, the alertness stimulation air flow, and rhythm air flow are combined. Alternatively, the control device 20 may control the air blower 12 such that two or more air flows selected from the refreshing air flow, the alertness stimulation air flow, and rhythm air flow are mixed.

In the case where two or more air flows are combined, the two or more air flows selected from the refreshing air flow, the alertness stimulation air flow, and rhythm air flow are separately generated in different time slots. In the case where portions of at least two time slots among time slots in which two or more types of air flows are respectively generated are overlapped, for example, one of the time slots is shifted so as to eliminate the overlap, and the respective air flows are separately generated. In the case where the time slot is shifted, as described above, the control device 20 is configured to set priority levels for the refreshing air flow, the alertness stimulation air flow, and the rhythm air flow, generate the air flow having a high priority level in the original time slot, and generate the air flow having a low priority level in a time slot that is delayed from the original time.

Here, a case is assumed in which the refreshing air flow is set so as to have a priority level higher than that of the alertness stimulation air flow, and portions of a time slot in which the refreshing air flow is to be generated and a time slot in which the alertness stimulation air flow is to be generated overlap. In this case, although the refreshing air flow is to be generated in a time slot according to parameters set in the memory 24, the alertness stimulation air flow is to be generated in a time slot that is delayed from a time slot that is determined according to the parameters set in the memory 24 so as not to overlap with the time slot in which the refreshing air flow is to be generated.

On the other hand, in the case where two or more air flows are mixed, two or more air flows selected from the refreshing air flow, the alertness stimulation air flow, and rhythm air flow are generated in the same time slot. In the case where portions of at least two time slots among a plurality of time slots in which two or more air flows are respectively generated overlap, for example, one of the air flows is selected in a period in which time slots overlap. That is, overlap of time slots respectively occupied by different types of air flows is allowed. In the case where overlap of time slots in which different types of air flows are respectively generated is allowed, the control device 20 is desirably configured to set priority levels for the refreshing air flow, the alertness stimulation air flow, and the rhythm air flow, and adopt the air flow having a high priority level in a period in which time slots overlap. The priority levels are desirably set such that an air flow having a higher maximum speed has a higher priority level.

Here, a case is assumed in which a portion of a time slot in which the alertness stimulation air flow is to be generated overlaps with a time slot in which the refreshing air flow is to be generated. Because the maximum speed of the alertness stimulation air flow is larger than that of the refreshing air flow, here, it is assumed that the alertness stimulation air flow is set so as to have a priority level higher than that of the refreshing air flow. Under this condition, the control device 20 controls the air blower 12 such that the alertness stimulation air flow is generated in a period in which a time slot in which the refreshing air flow is to be generated overlaps with a portion of a time slot in which the alertness stimulation air flow is to be generated.

FIG. 6 illustrates an example in which the control device 20 controls the air blower 12 such that three types of air flows, namely the refreshing air flow, the alertness stimulation air flow, and the rhythm air flow, are combined. Time at a left end in FIG. 6 corresponds to a start time of intellectual work. In FIG. 6, the refreshing air flow, the alertness stimulation air flow, and the rhythm air flow are separately generated so as not to overlap with each other. Note that unevennesses at upper ends of bars corresponding to the refreshing air flow and unevennesses at upper ends of bars corresponding to the alertness stimulation air flow indicate that the air speed of the refreshing air flow and the alertness stimulation air flow changes over time.

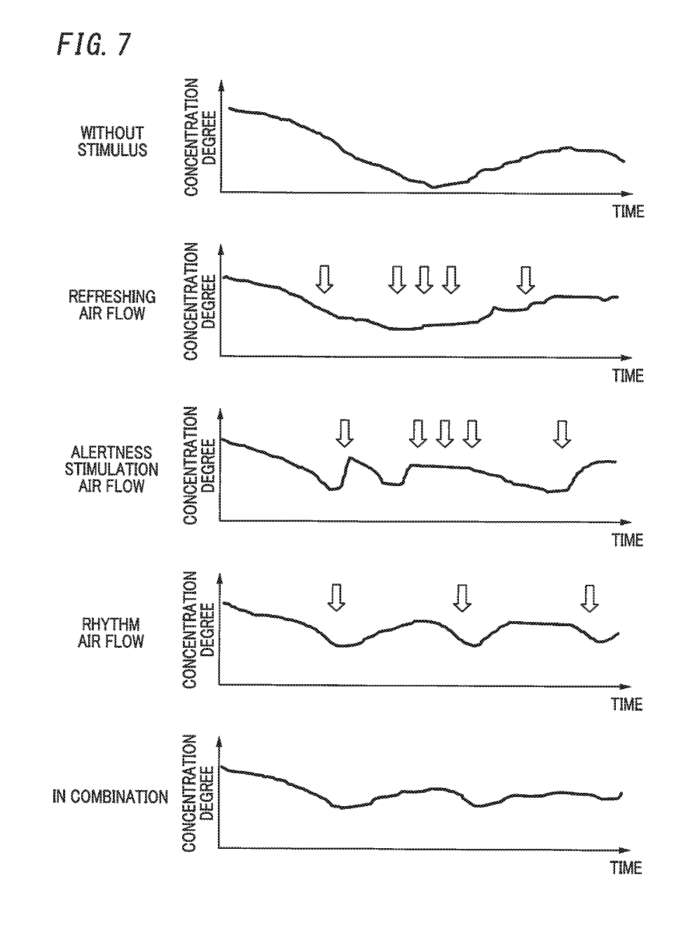

FIG. 7 illustrates a change of the concentration degree over time when a stimulus is not applied to the user, changes of the concentration degree over time when only the refreshing air flow, only the alertness stimulation air flow, and only the rhythm air flow are respectively generated, and a change of the concentration degree over time when the three types of air flows are generated in combination. Timings at which air flows are generated in the cases where only the refreshing air flow, only the alertness stimulation air flow, and only the rhythm air flow are respectively generated are indicated by arrows in FIG. 7.

According to FIG. 7, in the case where only the refreshing air flow is used, lowering of the concentration degree can be suppressed compared with the case where a stimulus is not applied to the user. However, the trend of the change in concentration degree shows a similar trend when a stimulus is not applied. On the other hand, in the case where only the alertness stimulation air flow is used, a period occurs in which the concentration degree changes rapidly. The concentration degree is, for the most part, maintained at a high state. Also, in the case where only the rhythm air flow is used, the concentration degree periodically changes in accordance with the rhythm air flow.

In the case where the refreshing air flow, the alertness stimulation air flow, and the rhythm air flow are used in combination, the concentration degree is maintained in a relatively high state, and the change in the concentration degree is small. That is, the concentration degree can be maintained in a high state over the whole period in which intellectual work is performed, and as a result productivity can be said to be improved compared with a case where a stimulus is not applied.

Although the ventilator 11 and the air blower 12 are used as the environment forming device 10 in the exemplary configuration described above, an air conditioner can be used as the environment forming device 10, as described above. The air conditioner can control temperature, and includes a function of forming an air flow as well. Furthermore, the air conditioner may be configured so as to perform control of humidity, and a configuration in which ventilation with the outside air is enabled is also known. Also, an air conditioner is known in which a direction of an air flow is controlled.

That is, when an air conditioner is used as the environment forming device 10, the air conditioner can be caused to function as an air flow forming device similarly to the air blower 12. That is, the air conditioner can control formation of an air flow and stop of an air flow, and can control the air flow speed. Therefore, as a result of controlling the air conditioner, the refreshing air flow, the alertness stimulation air flow, and the rhythm air flow can be generated.

Furthermore, when an air conditioner is used as the environment forming device 10, temperature of the air flow can be controlled according to a season or room temperature. Because it is known that an apparent temperature decreases as an air speed increases, in general, when the air speed and the temperature are controlled in combination considering the apparent temperature, an effect of stimulus applied to the user can be increased compared with a case where only the air speed is controlled.

For example, in the case where the room temperature is high in summer, if only formation of an air flow is performed, there is a case where the apparent temperature cannot be sufficiently lowered, and an appropriate stimulus cannot be applied to the user. In particular, when the alertness stimulation air flow is applied, it is not desirable that the air flow temperature is higher than the room temperature. Accordingly, if the air conditioner forms an air flow having a temperature equal to or lower than the room temperature, and the air flow is blown to the user, the apparent temperature is lowered, and a stimulus appropriate to the user can be applied. In the case where, in summer, the air conditioner is used for this purpose, the temperature of an air flow that is blown from the air conditioner is selected from a range from a temperature several degrees lower than the room temperature to the room temperature.

On the other hand, in the case where the room temperature is low in winter, it is possible, by using the air conditioner, to maintain a body temperature in every part of the body in a comfortable range, and to apply a stimulus that influences the power of concentration by an air flow. For example, by making the temperature of air that is blown to an upper body approximately the same as the room temperature, and making the temperature of air that is blown to feet higher than the room temperature, a state in which a head is kept cool and feet are kept warm can be realized, and therefore the apparent temperature can be maintained, and the power of concentration can be maintained or improved by applying a stimulus by air to the user as well.

Here, in the case where it is difficult to respectively blow flows of air having different temperatures to two or more portions of the user at the same time by one air conditioner, the portion to which an air flow generated by the air conditioner is blown may be changed from a head portion to feet of the user, or from the feet to the head portion. In this case, a temperature of air in a period in which the air is blown to the upper body may be different from a temperature of air in a period in which the air is blown to the feet.

Note that in the case where the air conditioner that performs the above-described operation is used as the environment forming device 10, the air blower 12 can be omitted, and also the ventilator 11 can be omitted if the air conditioner is equipped with a ventilation function. That is, the environment forming device 10 can be configured by only the air conditioner. On the other hand, the air conditioner and the air blower 12 may be used in combination, and a configuration is possible in which the room temperature is controlled by the air conditioner and the air flow speed is controlled by the air blower 12, for example.

Incidentally, an operation such as a following example is possible in a case where a target value set for an environmental factor that is measured by the sensor 40 is applied in a configuration in which the operation of the environment forming device 10 is controlled according to the elapse of time, which is measured by the clock 25. Here, a case is assumed where the environment forming device 10 is the ventilator 11, the environmental factor being focused on is carbon dioxide concentration, and the target value is 400 ppm. The target value is set to two thirds or less, or desirably a half or less of typical indoor carbon dioxide concentration. That is, the target value is set to 700 ppm or less, or desirably set to 500 ppm or less. Also, in an example described in the following, it is assumed that the concentration degree starts to lower when 25 minutes elapses from the start of intellectual work.

In this case, the processor 21 attempts to maintain or improve the concentration degree by causing the ventilator 11 to operate with high power (high speed air flow) at a point in time when 25 minutes has elapsed from the start of intellectual work. Thereafter, the processor 21 causes the ventilator 11 to return to an original state when 10 minutes has elapsed since the carbon dioxide concentration measured by the sensor 40 has reached 400 ppm, which is the target value, for example.

Also, in the case where a stimulus is applied to the user by blowing air, the concentration degree of the user changes immediately after the air blower 12 is controlled. On the other hand, in the case where the indoor air quality is adjusted using the ventilator 11, it takes a relatively long time (20 minutes, for example) since the ventilator 11 has started operation until the indoor air quality is improved to a desired quality. Therefore, the operation of the ventilator 11 may be started prior to the time slot in which lowering of the concentration degree is anticipated by an amount of time needed for the indoor air quality to be improved to a desired quality.

Note that in the case where the environment forming device 10 uses a rotational motor as a power source as with the ventilator 11, the target value may be determined with a rotation number of the motor. That is, the timing when the operation of the ventilator 11 is returned to the original state is determined using the rotation number of the motor as the target value without using the sensor 40.

Furthermore, the processor 21 may be configured such that the operation of the environment forming device 10 is changed depending on the concentration degree. For example, the concentration degree is classified into two or more stages, and the air flow speed, the target value, or the like may be changed for each of the stages. Furthermore, a configuration may be adopted in which biorhythm such as circadian rhythm is considered, and the operation of the environment forming device 10 is changed according to the time slots.

Note that in the case where an odor is focused on, concentration of a hydrocarbon-based compound or the like may be measured instead of the carbon dioxide concentration as the air quality. In this case, an environment forming device 10 selected from a ventilation device, an air cleaner, and the like is used. Also, an odor sensor is used as the sensor 40. A CIAQ (Composite Index of Air Quality) number in which concentration of a hydrocarbon-based compound or the like is used is known as an index for numerically showing the degree of the odor. In the case where the sensor 40 is an odor sensor in which the CIAQ number is the output value, the target value is set to 20 or less, or desirably set to 10 or less.

The odor is important in periods immediately before and after the point in time when intellectual work is started from a viewpoint of an effect on the concentration degree. Therefore, in the case where the odor is focused on, the control device 20 controls the environment forming device 10 such that the CIAQ number is made small as long as possible in a period immediately before and after the point in time when the intellectual work is started. In order to make such control possible, in the case where the odor is focused on, the operation of the environment forming device 10 needs to be started before the start of intellectual work. That is, the user may start intellectual work when a predetermined time has elapsed after directing the operation of the environment forming device 10. Alternatively, a configuration may be adopted in which a schedule is set in which a time when intellectual work is to be started is determined, and the control device 20 automatically starts operation of the environment forming device 10 a predetermined amount of time before the time when intellectual work is to be started.

In the case where this configuration is adopted, the control device 20 desirably causes the environment forming device 10 to operate such that the CIAQ number measured by the sensor 40 does not exceed 20 after the start of intellectual work.

As described above, the environment control system of the present embodiment includes an environment forming device 10 and a control device 20. The environment forming device 10 is configured to perform at least one of formation of an air flow in a work space and ventilation of the work space. The control device 20 is configured to control operation of the environment forming device 10. Here, the control device 20 is configured to control operation of the environment forming device 10 such that a concentration degree is maintained or improved, the concentration degree being a degree of concentration of attention of a user who is present in the work space.

The environment control system described above causes at least one of formation of an air flow and ventilation to act on the concentration degree, and therefore the concentration degree of a user can be maintained or improved without using any of a visual stimulus, an auditory stimulus, and an olfactory stimulus.

The environment forming device 10 is an air flow forming device (such as air blower 12) configured to form an air flow such that air is blown to the user, and the control device 20 is desirably configured to control the air flow forming device such that formation of an air flow and stop of an air flow are repeated. In this configuration, it is desirable that the control device 20 is configured to determine: a maximum speed of air that the air flow forming device blows to the user, an operating time during which the air flow forming device forms an air flow, and a stop time during which the air flow forming device stops an air flow; select a maximum speed range of air that the air flow forming device blows to the user from a group of 0.2 m/s, 0.4 to 0.7 m/s, 1.5 to 3.0 m/s; and determine the operating time and the stop time depending on the maximum speed range.

With this environment control system, air flows depending on factors that lower the concentration degree can be formed by the air flow forming device, and as a result lowering of the concentration degree due to each of the factors can be suppressed. Also, because a stimulus is applied to the user by an air flow formed by the air flow forming device, if the air flow forming device is provided with an interface with the control device 20, the environment control system can be easily realized by connecting the control device 20 with the air flow forming device.

The environment control system desirably includes a measuring device 30 configured to measure the concentration degree of the user in the work space. In this configuration, the control device 20 is configured to control operation of the environment forming device 10 such that the concentration degree measured by the measuring device 30 is maintained or improved.

The environment control system performs feedback control by monitoring the concentration degree of the user with the measuring device 30, and therefore the environment forming device 10 can be controlled at an appropriate timing at which the concentration degree is to be maintained or improved.

Also, the control device 20 may include a clock 25 configured to measure time. In this configuration, the control device 20 stores in advance a relationship between time and a concentration degree. The control device 20 is configured to control operation of the environment forming device 10 such that the concentration degree of the user is maintained or improved based on time measured by the clock 25 according to the relationship.

The environment control system performs open control using the relationship between an elapsed time and a concentration degree of the user, and thus can be realized with a simple configuration without using the measuring device 30.

The environment control system may include a sensor 40 configured to measure an environmental factor focusing on air quality in the work space. In this configuration, the control device 20 is configured to control operation of the environment forming device 10 such that the environmental factor measured by the sensor 40 reaches a preset target value.

In the environment control system, the operation of the environment forming device 10 is controlled with consideration given to the air quality in the work space, and therefore the concentration degree can be maintained or improved as a result of improving the air quality such as carbon dioxide concentration or odor that acts on the concentration degree.

The environment forming device 10 is a ventilation device configured to perform ventilation of the work space, and the sensor 40 may be configured to measure carbon dioxide concentration in the work space as the environmental factor. In this configuration, the control device 20 desirably controls the ventilation device such that the carbon dioxide concentration in the work space measured by the sensor 40 does not exceed 700 ppm.

In the environment control system, the carbon dioxide concentration in the work space is adjusted so as not to reach a high concentration, and therefore lowering of the alertness level can be suppressed, and as a result lowering of the concentration degree can be suppressed.

Note that the embodiment described above is an example of the present invention. The present invention is not limited to the embodiment described above, and it should be obvious that, in addition to the above embodiment, various modifications can be made according to the design or the like, as long as they do not depart from the technical concept of the present invention.

1. An environment control system comprising:
an environment forming device configured to perform at least one of formation of an air flow in a work space and ventilation of the work space; and
a control device configured to control operation of the environment forming device,
the control device being configured to control operation of the environment forming device such that a concentration degree is maintained or improved, the concentration degree being a degree of concentration of attention of a user who is present in the work space.

2. The environment control system according to claim 1,
wherein the environment forming device is an air flow forming device configured to form an air flow such that air is blown to the user,
the control device is configured to control the air flow forming device such that formation of an air flow and stop of an air flow are repeated,
the control device is configured to determine a maximum speed of air that the air flow forming device blows to the user, an operating time during which the air flow forming device forms an air flow, and a stop time during which the air flow forming device stops an air flow,
the control device is configured to select a maximum speed range of air that the air flow forming device blows to the user from a group of 0.2 m/s, 0.4 to 0.7 m/s, 1.5 to 3.0 m/s, and
the control device is configured to determine the operating time and the stop time depending on the maximum speed range.

3. The environment control system according to claim 1, further comprising a measuring device configured to measure the concentration degree of the user in the work space,
wherein the control device is configured to control operation of the environment forming device such that the concentration degree measured by the measuring device is maintained or improved.

4. The environment control system according to claim 1,
wherein the control device
comprises a clock configured to measure time,
stores in advance a relationship between time and a concentration degree, and
is configured to control operation of the environment forming device such that the concentration degree of the user is maintained or improved based on time measured by the clock according to the relationship.

5. The environment control system according to claim 1, further comprising a sensor configured to measure an environmental factor focusing on air quality in the work space,
wherein the control device is configured to control operation of the environment forming device such that the environmental factor measured by the sensor becomes a preset target value.

6. The environment control system according to claim 5,
wherein the environment forming device is a ventilation device configured to perform ventilation of the work space,
the sensor is configured to measure carbon dioxide concentration in the work space as the environmental factor, and
the control device is configured to control the ventilation device such that the carbon dioxide concentration in the work space measured by the sensor does not exceed 700 ppm.

7. A control device to be adopted in the environment control system according to claim 1.

8. A computer-readable recording medium recording a program causing a computer to function as the control device to be adopted in the environment control system according to claim 1.

9. The environment control system according to claim 2, further comprising a measuring device configured to measure the concentration degree of the user in the work space,
wherein the control device is configured to control operation of the environment forming device such that the concentration degree measured by the measuring device is maintained or improved.

10. The environment control system according to claim 2,
wherein the control device
comprises a clock configured to measure time,
stores in advance a relationship between time and a concentration degree, and
is configured to control operation of the environment forming device such that the concentration degree of the user is maintained or improved based on time measured by the clock according to the relationship.
